(19) United States
(12) Patent Application Publication
(10) Pub. No.: US 2017/0284597 A1
(43) Pub. Date: Oct. 5, 2017

(54) MAGNETIC CORNER MOUNTING UNIT

(71) Applicant: Su-E Tan, San Gabriel, CA (US)

(72) Inventor: Su-E Tan, San Gabriel, CA (US)

(21) Appl. No.: 15/474,941

(22) Filed: Mar. 30, 2017

Related U.S. Application Data
(60) Provisional application No. 62/315,204, filed on Mar. 30, 2016.

(51) Int. Cl. F16M 13/02; F16B 1/00

(52) U.S. Cl. CPC F16M 13/025; F16M 13/022; F16B 1/00; F16B 2001/0035

(57) ABSTRACT

A corner mounting unit having at least one receptacle for holding an object or item and shaped to fit around a corner of a wall of an interior housing or office. The corner mounting unit generally has two outer walls that are perpendicular to each other that mate with a corner of an interior housing wall. Along those two outer walls are magnets that allow the corner mounting unit to magnetically attach to the metal found in the corner of a housing wall.

### CROSS-REFERENCE TO RELATED APPLICATION

This application claims priority to U.S. Provisional Application No. 62/315,204, filed Mar. 30, 2016, which is hereby incorporated by reference in its entirety as if fully recited herein.

### BACKGROUND OF THE INVENTION

The present invention generally relates to a corner mounting unit, specifically, a magnetic corner mounting unit that magnetically attaches to a corner of an interior wall of a home or office.

Traditionally, shelving units need to be mounted using fasteners such as nails and/or screws, involving hardware, tools, and labor. Moreover, once the shelving unit is removed, holes are left where the nails and screws were inserted, leaving an unsightly appearance.

In the United States, most housing and office interiors use drywall. And with drywall construction, most, if not all, corners have a stud including some sort of metal piece. The magnetic corner mounting unit in accordance with the present invention is able to attach to the metal piece of the stud and provide additional storage and functional space to users. Removal of the magnetic corner mounting unit does not leave holes and other markings common with other wall-mount systems.

### SUMMARY OF THE INVENTION

The present invention includes a corner mounting unit having magnets provided along at least two walls of the corner mounting unit allowing the unit to magnetically attach to a metal portion of studs found throughout an interior of a home or office. The metal portion of the stud allows the corner mounting unit in accordance with the present invention to be mounted without taking up any floor space, thus utilizing otherwise “dead” space.

### BRIEF DESCRIPTION OF THE DRAWINGS

A more complete understanding of the present invention may be obtained with reference to the Detailed Description when taken in conjunction with the accompanying drawings.

FIGS. 1A-1D show an embodiment of a corner mounting unit in accordance with the present invention;

FIGS. 2A-2E show another embodiment of a corner mounting unit in accordance with the present invention;

FIGS. 3A-3E show another embodiment of a corner mounting unit in accordance with the present invention;

FIGS. 4A-4E show another embodiment of a corner mounting unit in accordance with the present invention;

FIGS. 5A-5E show another embodiment of a corner mounting unit in accordance with the present invention;

FIGS. 6A-6D show another embodiment of a corner mounting unit in accordance with the present invention;

FIGS. 7A-7E show another embodiment of a corner mounting unit in accordance with the present invention; and

FIGS. 8A-8E show another embodiment of a corner mounting unit in accordance with the present invention.

### DETAILED DESCRIPTION OF THE INVENTION

The corner mounting unit generally can comprise at least one receptacle for holding an object or item and is shaped to fit around a corner of a wall of an interior housing or office. The corner mounting unit generally has two outer walls that are perpendicular to each other that mate with a corner of an interior housing wall. Within those two outer walls are magnets that allow the corner mounting unit to magnetically attach to the metal portion of a stud found in the corner of a interior wall of a house, other dwelling or office.

The corner mounting unit in accordance with the present invention can be configured to hold a variety of items, including, but not limited to, electronic items, plants, keys, pens and note pads, small toys, and other personal items.

The mounting unit can be a variety of shapes, sizes, colors and materials as shown in the various embodiments. For example, the corner unit can be square or rectangular, rounded, triangular, arrow-shaped, pie-shaped, etc., to name a few. The corner unit can have multiple and separate compartments to enable organization. These multiple compartments can be of different shapes, sizes and heights to accommodate a variety of objects. The various compartments or receptacles can have varying heights within a single mounting unit.

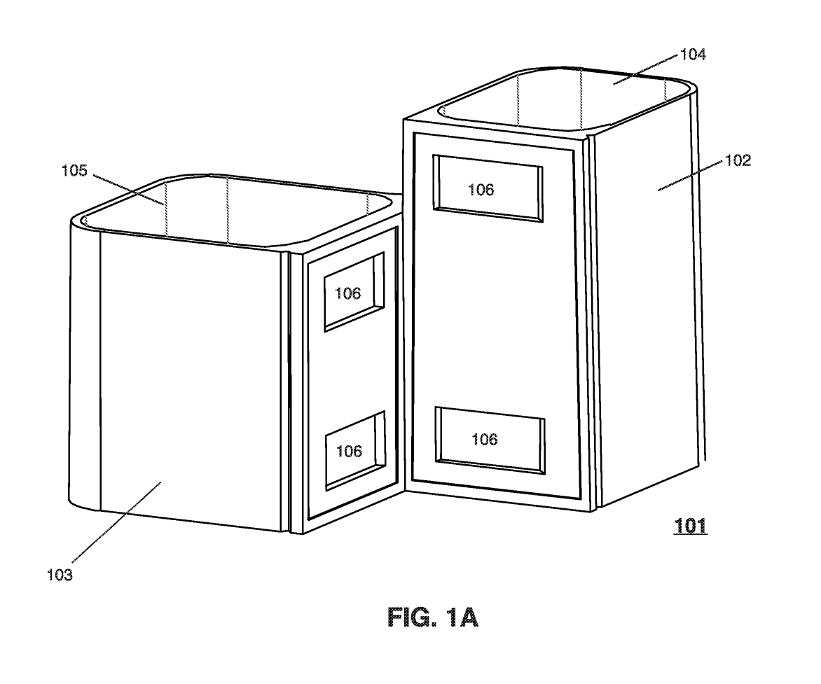

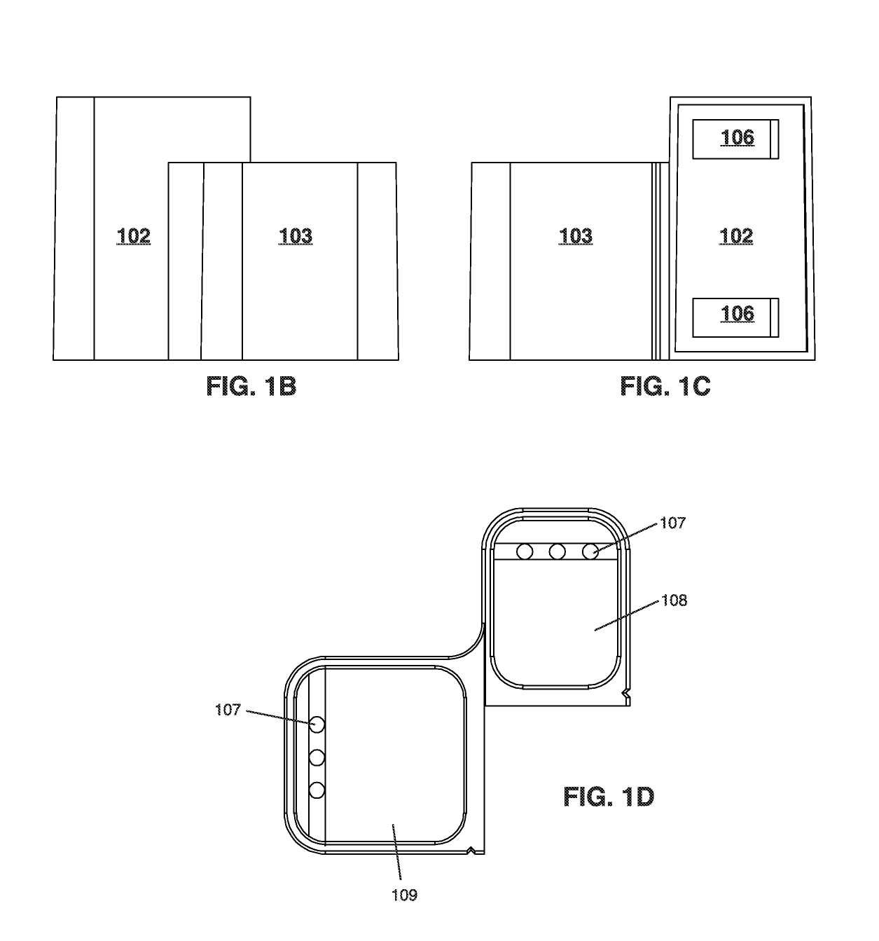

Turning now to the Figures, FIGS. 1A-1D show various views of an exemplary corner mounting unit 101. Corner mounting unit 101 has a first receptacle 102 and a second receptacle 103. First receptacle 102 has four sides, an opening 104 and a base 108. Second receptacle 103 has four sides, an opening 105 and a base 109. In this example, first and second receptacles 102 and 103 have varying heights. Formed on one of four sides (outer wall) of each receptacle is at least one magnet 106 to attach to a metal portion of a building stud. Formed in base 108 and 109 of first and second receptacles 102 and 103 are holes 107. When a receptacle is used for plants, holes 107 can be used to provide drainage.

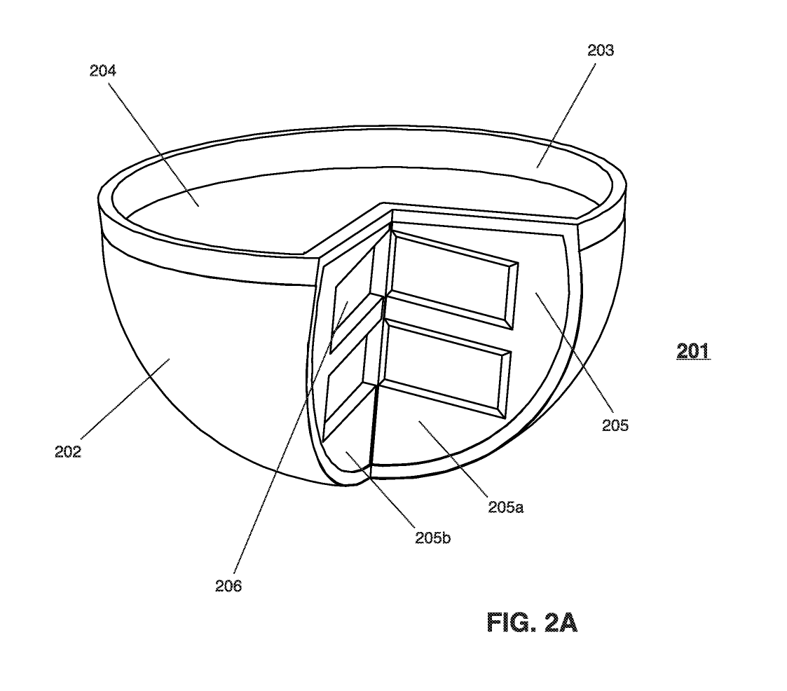

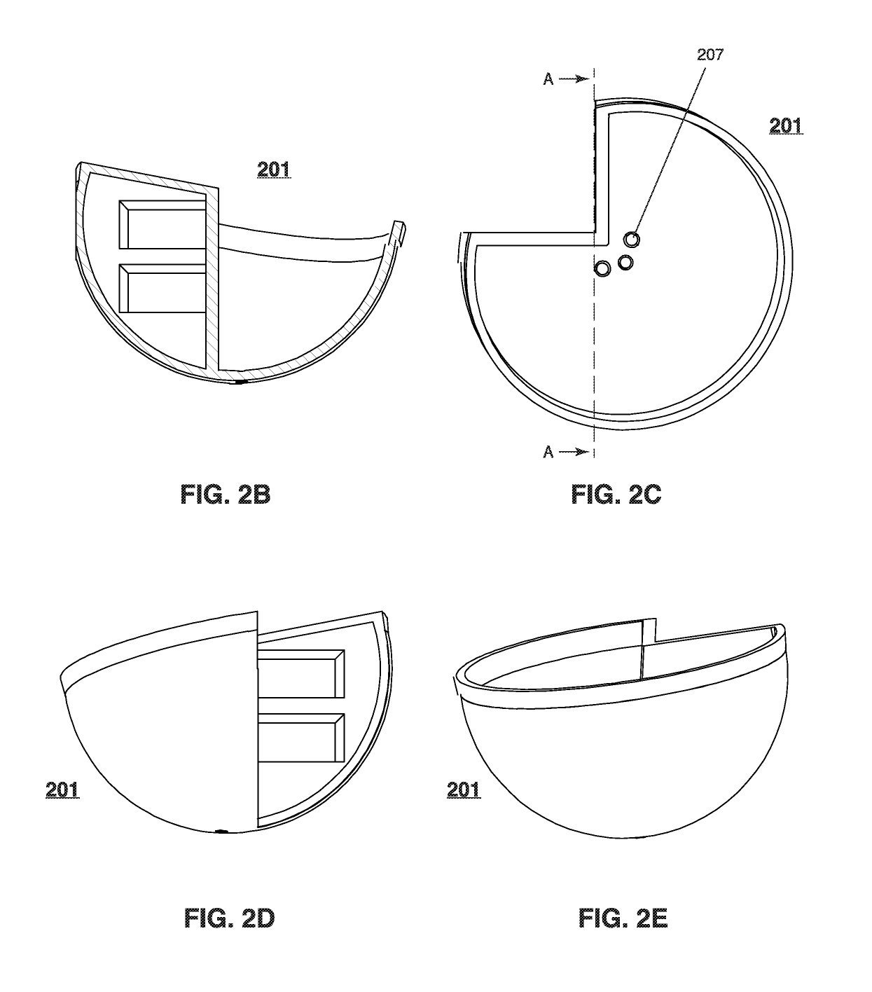

FIG. 2A-2E show various view of an exemplary corner mounting unit 201. FIG. 2B shows a cross-section taken along line A of FIG. 2C. Corner mounting unit 201 has a semi-spherical main body 202 with a rim 203 and an opening 204. Formed within semi-spherical main body 202 is a cut-out portion 205 with perpendicular walls 205a and 205b. Formed on perpendicular walls 205a and 205b are magnets 206. Formed at a bottom of semi-spherical main body 202 are holes 207. When a receptacle is used for plants, holes 207 can be used to provide drainage.

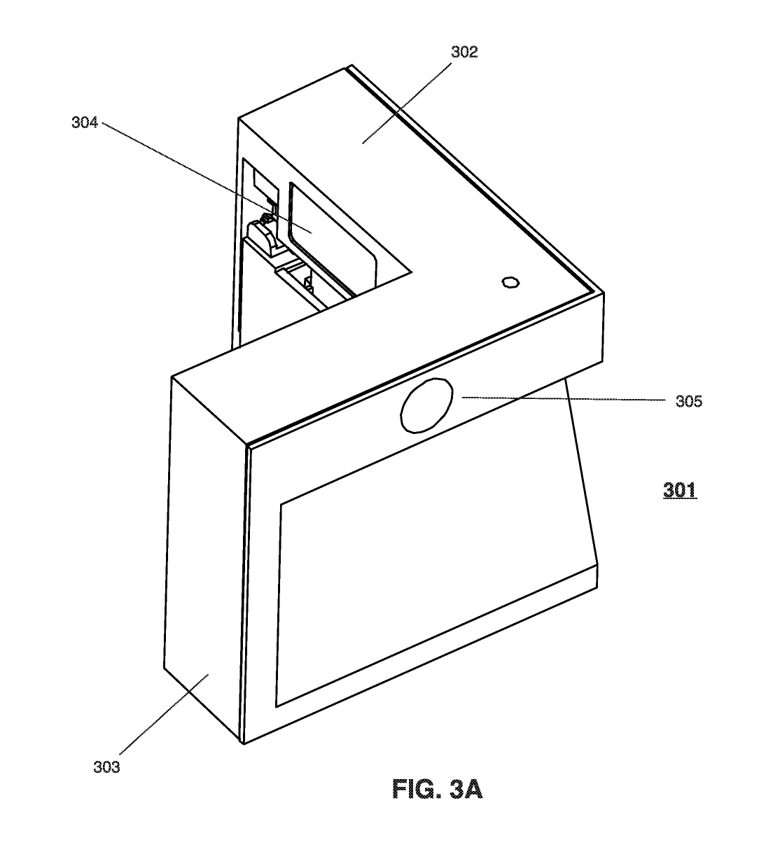

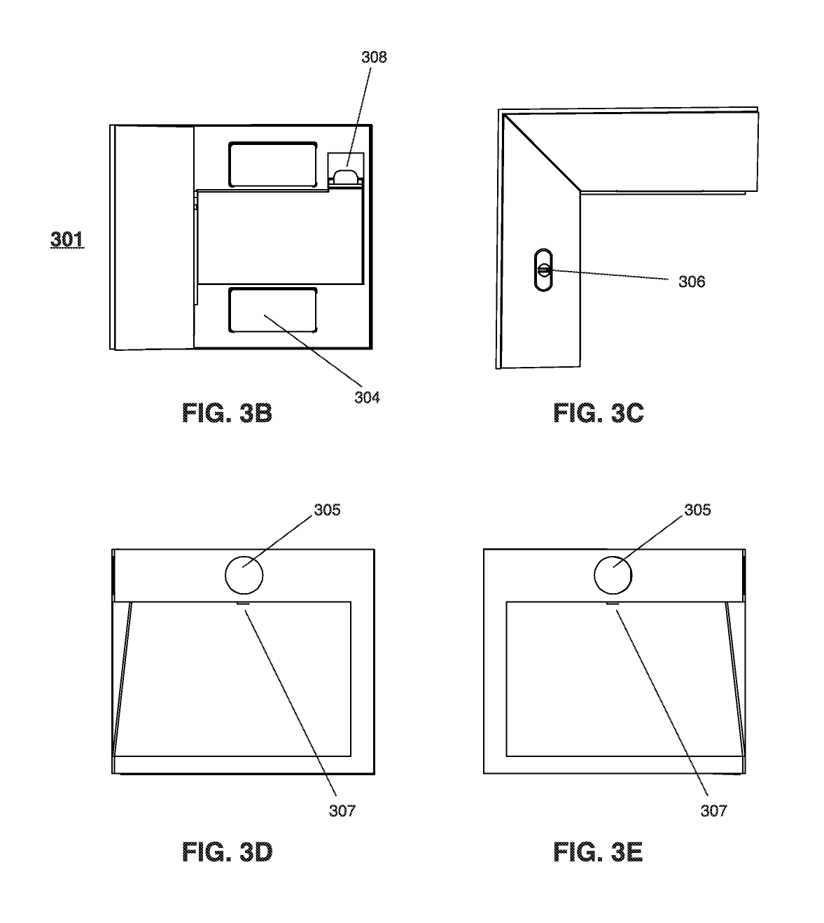

FIG. 3A-3E show various views of an exemplary corner mounting unit 301 with a night light 305. Corner mounting unit 301 has a top portion 302 and side walls 303. Magnets 302 are formed on an inside portion of corner mounting unit 301. Formed on an outside portion of corner mounting unit 301 is an infrared sensor 305. Below infrared sensor 305 is a night light 307. Night light 307 can be an LED light. A switch 306 can also be provided on corner mounting unit 301 to allow for manual operation of light 307. Electrical components 308 (e.g., battery housing) are also held within corner mounting unit to allow for operation of infrared sensor 305 and light 307.

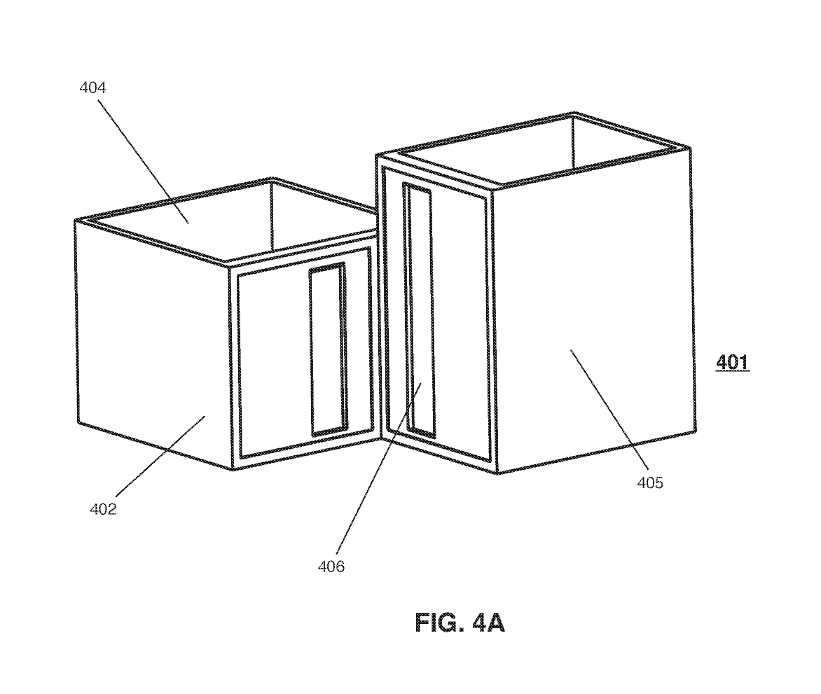

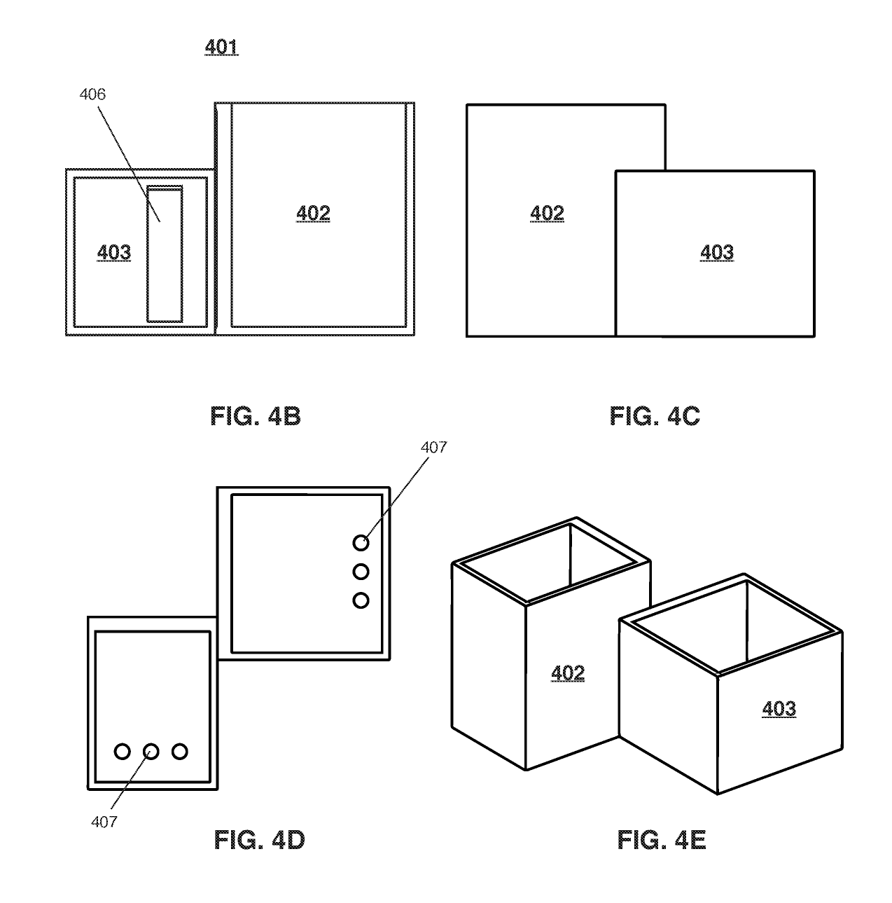

FIG. 4A-4C show various views of an exemplary corner mounting unit 401. Corner mounting unit 401 has a first receptacle 402 and a second receptacle 403. First receptacle 402 has four sides, an opening 404 and a base 408. Second receptacle 403 has four sides, an opening 405 and a base 409. In this example, first and second receptacles 402 and 403 have varying heights. Formed on one of four sides (outer wall) of each receptacle is at least one magnet 406 to attach to the metal portion in the wall. In this exemplary unit, a single magnet 406 extends along the height of both first and second receptacles 402 and 403. Formed in base 408 and 409 of first and second receptacles are holes 407. When a receptacle is used for plants, holes 407 can be used to provide drainage.

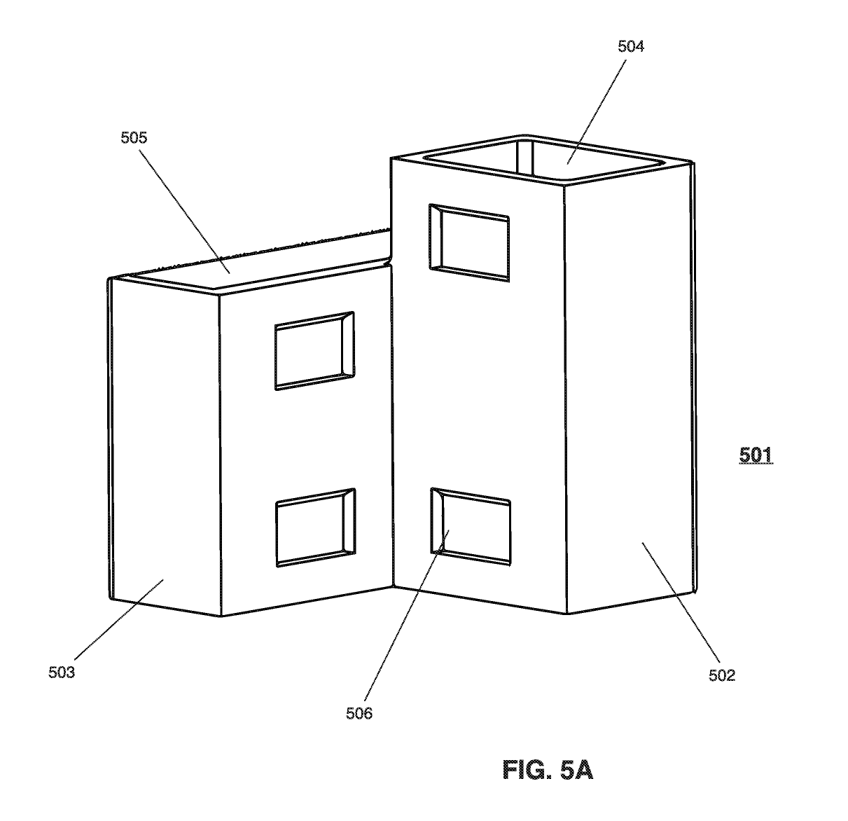

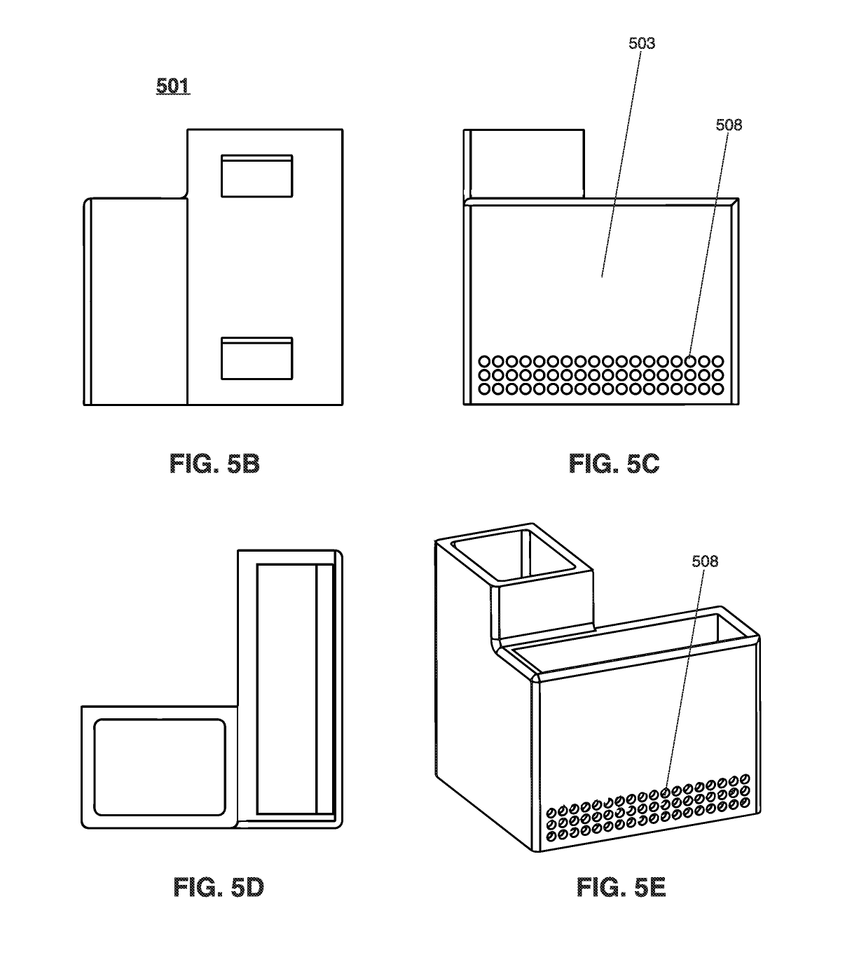

FIG. 5A-5E show various views of an exemplary corner mounting unit 501. Corner mounting unit 501 has a first receptacle 502 and a second receptacle 503. First receptacle 502 has four sides, an opening 504 and a base. Second receptacle 503 has four sides, an opening 505 and a base. In this example, first and second receptacles 502 and 503 have varying heights. Formed on one of four sides (outer wall) of each receptacle is at least one magnet 506 to attach to the metal portion in the wall. Formed on an opposite side of the wall on which magnet 506 is formed of second receptacle 503 is speaker 508. Second receptacle 503 is sized to fit a device such as a smart phone and can communicate with speaker 508 via Bluetooth.

The corner mounting unit can also include a variety of electronic-related components. For example, FIGS. 5A-5E show an integrated speaker element, which amplifies sound from a smartphone, for example. These speakers can be Bluetooth capable. Other electronic components, such as a clock, alarm, thermometer, night light, motion sensors, for example, can also be integrated into the corner mounting unit.

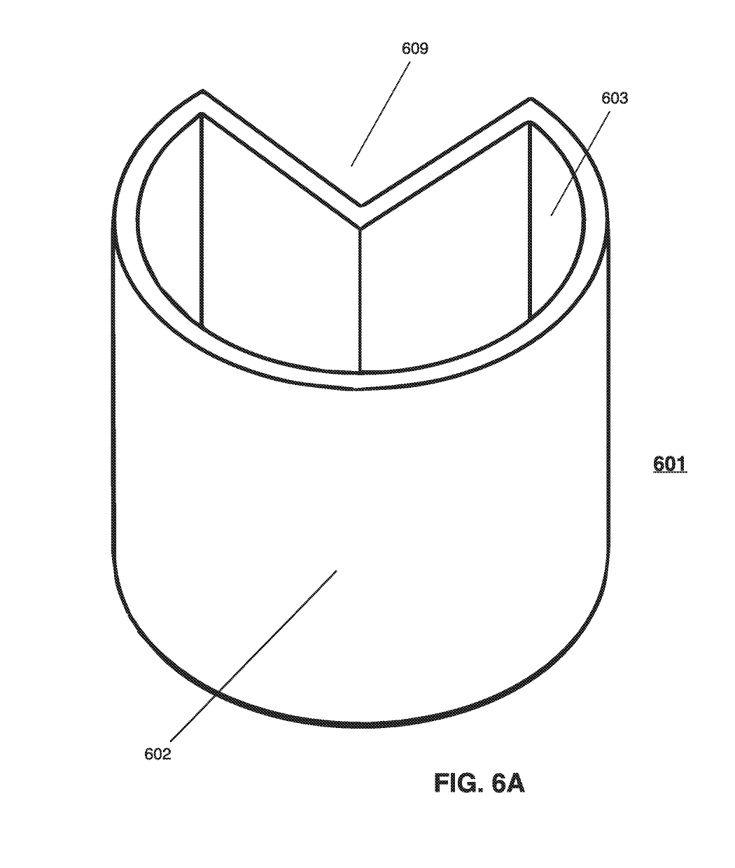

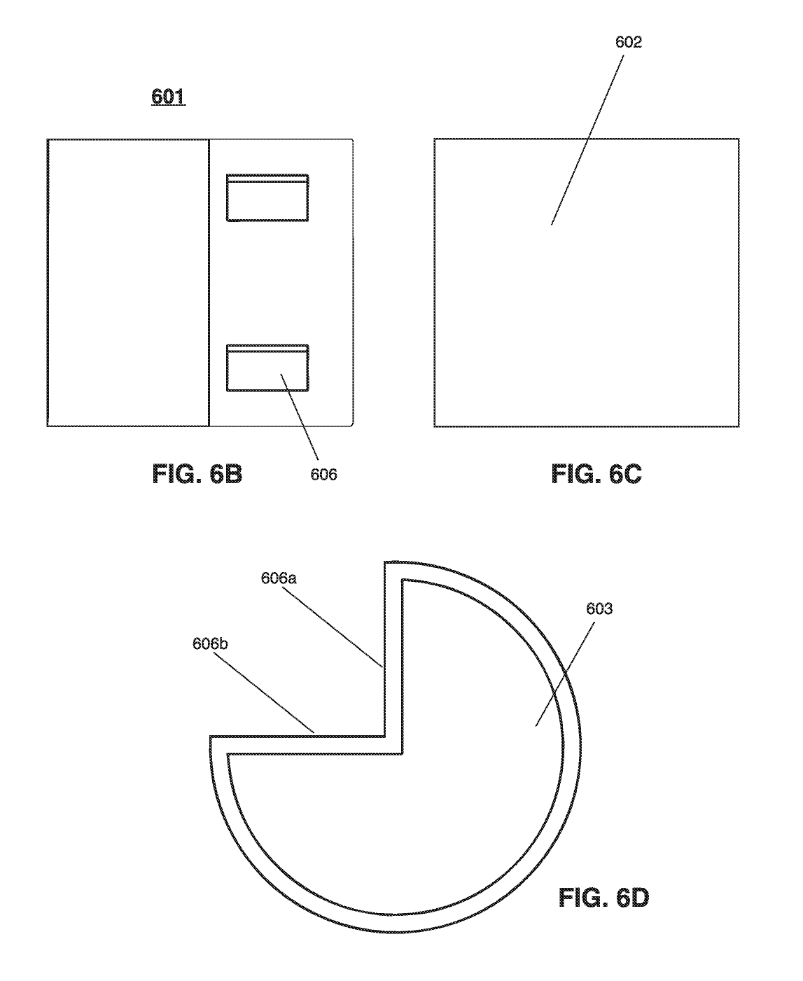

FIGS. 6A-6D show exemplary corner mounting unit 601 with a cylindrical main body portion 602 and opening 603. A cut-out portion 604 is formed in cylindrical main body portion 602. Cut-out portion has two perpendicular walls 604a and 604b on which magnets 606 are formed.

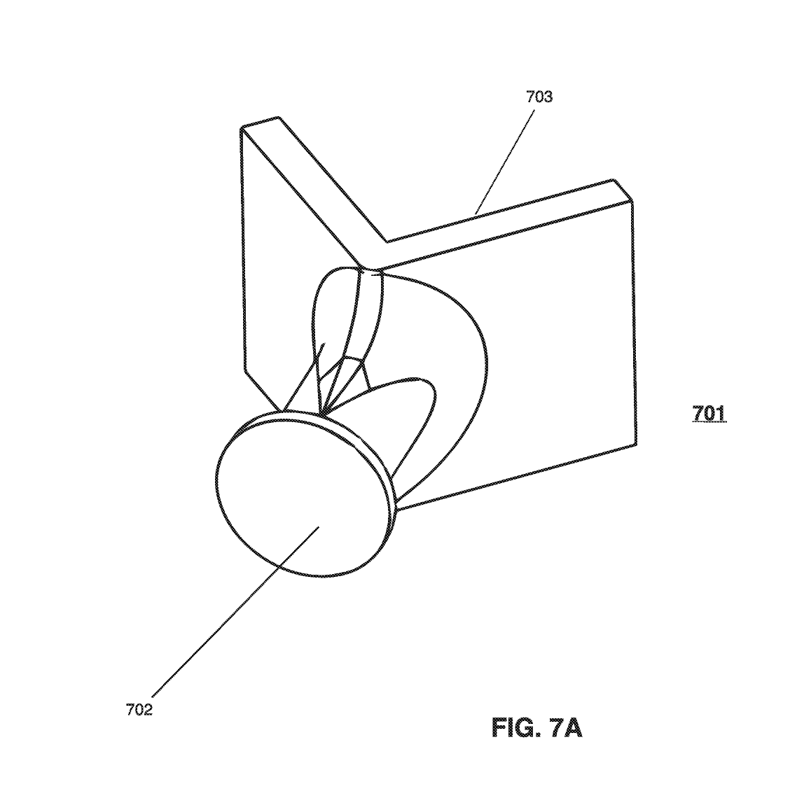

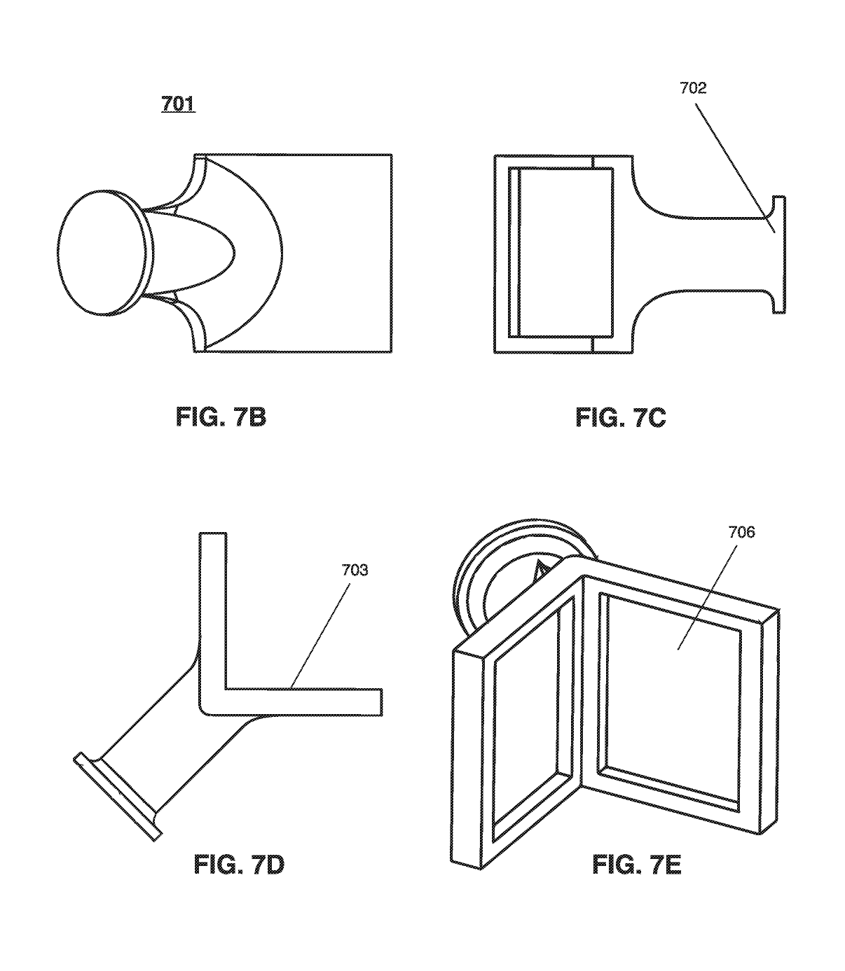

FIGS. 7A-7E show exemplary corner mounting unit 701 with a hook or hanger 702 attached thereto. Corner mounting unit 701 has a perpendicular portion 703 on which magnets 706 are formed.

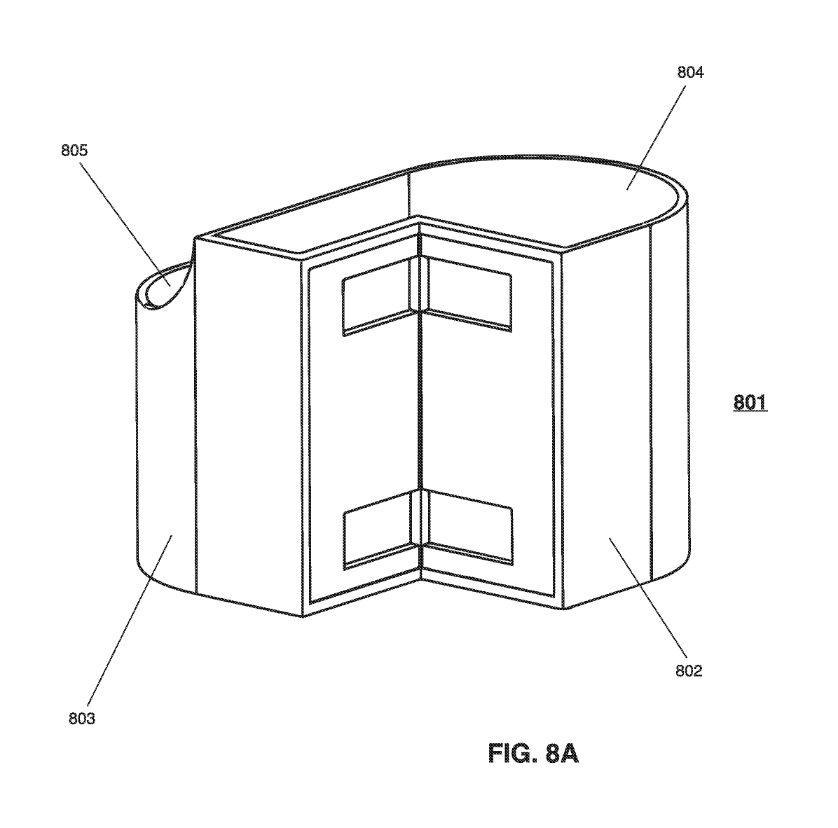

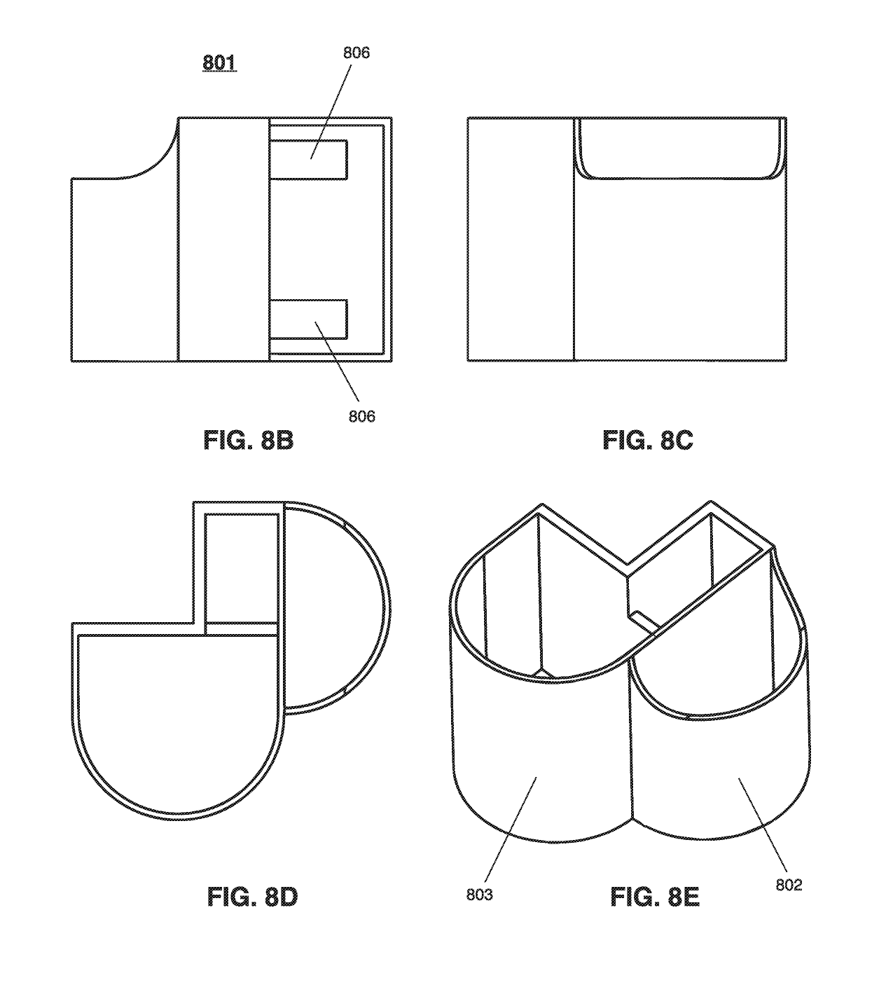

FIGS. 8A-8E show an exemplary corner mounting unit 801 with first and second receptacles 802 and 803, respectively, and openings 804 and 805, respectively. Magnets 806 are provided on a perpendicular portion of first receptacle 802. Second receptacle 803 is formed on an outside of first receptacle 803. Second receptacle 803 is generally devoid of any magnets.

While the foregoing written description of the invention enables one of ordinary skill in the art to make and use the invention, those of ordinary skill in the art will understand and appreciate the existence of variations, combination, and equivalents of the embodiments, methods, and examples provided herein. The invention should, therefore, not be limited by the embodiments and examples disclosed here, but by all embodiments and methods within the scope and spirit of the invention as claimed.

1. A corner mounting unit comprising:
a first receptacle having four walls, a base and an opening formed therein;
a second receptacle having at least two walls, a base and an opening formed therein;
said first and second receptacles connected to each other;
at least one magnet formed on an outside of one of said four walls of said first receptacle; and
at least one magnet formed on an outside of one of said four walls of said second receptacles;
wherein the walls on which the at least one magnet is formed are perpendicular to each other.

2. The corner mounting unit of claim 1, wherein each of said first and second receptacles has a height, wherein the height of said first receptacle is greater than the height of said second receptacle.

3. The corner mounting unit of claim 1, wherein holes are provided at the base of at least one of said first and second receptacles.

4. The corner mounting unit of claim 1, wherein a speaker is provided on one of said first and second receptacles.

5. A corner mounting unit comprising:
a semi-spherical main body portion;
a cut-out portion formed in said semi-spherical main body portion;
said cut-out portion having two perpendicular side walls;
at least one magnet provided on each of said two perpendicular side walls; and
holes provided at a base of said semi-spherical main body portion.

6. A corner mounting unit comprising:
a main body portion having right and left portions;
each of said right and left portions having a top, bottom, inside wall, outside wall, and one side wall;
said right and left portions meeting to form a right angle; and
at least one magnet provided on the inside wall each of said right and left portions.

7. The corner mounting unit of claim 6, wherein a sensor is provided on one of said right and left portions, a light is provided on one of said right and left portions, and a switch is provided on one of said right and left portions of said main body portion.

8. The corner mounting unit of claim 6, wherein a suction cup extends from a corner formed by said right angle.
